(19) United States
(12) Patent Application Publication
(10) Pub. No.: US 2021/0192075 A1
(43) Pub. Date: Jun. 24, 2021

(54) PRIVACY CONTROLS FOR NETWORK DATA COMMUNICATIONS

(71) Applicant: Killi Inc., Toronto (CA)

(72) Inventors: Neil Terrance Sweeney, Toronto (CA); Robert Anthony Osborne, Toronto (CA)

(21) Appl. No.: 17/052,038

(22) PCT Filed: May 1, 2019
(86) PCT No.: PCT/CA2019/000059

§ 371 Date: Oct. 30, 2020

Related U.S. Application Data
(60) Provisional application No. 62/665,182, filed on May 1, 2018.

(51) Int. Cl. G06F 21/62; H04L 9/32

(52) U.S. Cl. CPC G06F 21/6245; H04L 9/3247

(57) ABSTRACT

Systems (1000, 200, 300, 400, 500) and network communication devices (100) enable originators and custodians (190) of potentially private or otherwise sensitive data to control access to and/or use of such data by others for social, economic, and other purposes. Such originators are enabled to consent to sharing of specific items of personal or other sensitive data, for desired purposes and under specified conditions, and can be entitled to incentives for sharing data in their control. Brokers or other managers of such sharing are enabled to generate and store records of consents given by such originators or custodians, and to access such records as needed in order to verify that valid consents were given prior to release of potentially private or sensitive data.

### DISCLAIMER

Aspects of the material disclosed in this application relate to the generation, control, administration, use, storage, and other processing of data pertaining to public, private, and otherwise potentially sensitive communications over networked data communications systems. Aspects of such generation, control, administration, use, storage, and processing may be subject to regulation by governmental and other agencies. The disclosure herein is made solely in terms of logical, physical, and economic communications possibilities, without regard to statutory, regulatory, or other legal considerations. Nothing herein is intended as a statement or representation that any system, method or process proposed or discussed herein, or the use thereof, does or does not comply with any statute, law, regulation, or other legal requirement in any jurisdiction; nor should it be taken or construed as doing so.

### FIELD OF THE INVENTION

The present disclosure relates to improved electronic data processing and communication systems, and related methods, programming structures, and stored media; the implementation of which open up new and very useful possibilities for allowing users of networked data communications systems to selectively control access to and use of private or otherwise sensitive data pertaining to their communications, and for enabling creation and secure storage of data which reliably records consents given by and to creators and other authorized custodians of such information for the use of private and otherwise sensitive data. In particular, the disclosure relates to devices, systems, methods, and machine-interpretable programming and/or other stored data products for the flexible and secure control of potentially private data transmitted over such networks, and of data sets representing consents authorizing access, use, and otherwise processing of such data.

### BACKGROUND OF THE INVENTION

Systems for enabling social, economic, and other types of electronic data communication, for a very wide variety of purposes, including personal, business, and official communications, are known. In a very large number of cases, such systems route signals representing data sets from originator to addressee through multiple intermediary devices, using multiple processes controlled by multiple parties; and communicated data is stored both permanently and temporarily in a wide variety of locations, and used for a wide variety of processes by a wide variety of parties.

Much of the data communicated is regarded, by its originators and others, as rightfully subject to varying expectations of security and/or privacy. This includes, or can be used to deduce, for example, names, demographic information, identification numbers, financial account information, addresses, relationships, purchasing and other behavioral patterns, and a very great number of other types of personal information.

Such expectations of privacy or security are not always respected, however, Communications participants, including some or all of originators, addressees, communications processors and network hosts, and enterprises, as well as governments, criminals, aggressive merchants and others, sometimes take unauthorized possession of the data and use it for purposes not authorized by its originator(s). As has been seen repeatedly in recent news reports, such use is often abusive toward the individual or entity that originated or otherwise controlled it, and in some cases can threaten great harm—physical, social, financial, and otherwise—to large numbers of people.

There is need of improvements in systems, methods, and devices for allowing originators and others who process data to control access to it by others, and to allow authorized users of the data to securely and permanently record permissions and consents.

### SUMMARY OF THE INVENTION

Systems, devices, methods, and computer programming products in accordance with the invention enable originators and custodians 190 of potentially private or otherwise sensitive data to control access to and/or use of such data by others for social, economic, and other purposes. Such originators are enabled to consent to sharing of specific items of personal or other sensitive data, for desired purposes and under specified conditions, and can be entitled to incentives for sharing data in their control. Brokers or other managers of such sharing are enabled to generate and store records of consents given by such originators or custodians, and to access such records as needed in order to verify that valid consents were given prior to release of potentially private or sensitive data

Thus, in various aspects, the present disclosure provides systems, devices, methods, and persistently-stored, machine-interpretable programming and/or other data products for the secure, controlled, collaborative, efficient, and convenient processing of transaction data, and methods of using them. In particular, the disclosure provides systems, devices, and computer program products for enabling the originators or custodians of potentially private or otherwise sensitive data to control access to and/or use of such data by others for social, economic, and other purposes.

In the same and other aspects, the invention provides systems, devices, methods, and persistently-stored, machine-interpretable programming and/or other data products for the generation and storage by users of such potentially private or otherwise sensitive data of secure, permanent records evidencing consents and authorizations given by originators and/or custodians of such data for sharing such data with other network users, by accessing and/or otherwise using such data for purposes approved by its originators or custodians.

In some embodiments, the invention enables the storage of private or other potentially sensitive information, and data representing authorizations and consents, in nodes controlled by the party(ies) that originated it or have custody of it, and/or by parties authorized by the originators or custodians.

In the same and other aspects and embodiments, party(ies) who wish to mine or otherwise access such information are enabled to securely and reliably offer incentives to those who originated it, in return for access, and to permanently and securely memorialize such offerings.

In the same and other aspects and embodiments, access to such information by such miners is partially or wholly controlled by an information broker or other independent party, with keys, authorizations, and consents pertaining to such access being stored in secure, distributed, or otherwise neutrally-controlled data storage such as private data stores and/or secure public ledgers.

For example, in various aspects and embodiments the invention provides data sharing management systems, which can be referred to as brokers, and corresponding user devices 100, data mining systems 300, methods, and stored machine readable instruction sets (programming products) configured for controlling secure, verified access to data records representing personally-identifiable data over electronic communications networks. Such data sharing management systems can, for example, be configured to receive, from a plurality of user devices such as smart phones or personal computers, by means of electronic communications networks, signals representing pluralities of transaction consent data sets, each consent data set representing at least one authorization given by an originator or custodian of data representing potentially private or otherwise sensitive information for the broker to access such data and to use it, and/or to share it with third parties such as marketers, information analysts, etc.

A consent data set suitable for use in accordance with such aspects and embodiments can, for example, comprise pluralities of encrypted data records, at least one of the encrypted data records representing one or more identifiers associated with an originator or authorized custodian of the data and/or a user of the device from which the consent data set is received, who is entitled to authorize access by others to personally-identifiable data. The same or other encrypted data records of such sets can further represent one or more request transaction identifiers associated with request(s) for personally-identifiable information received by the data sharing management system from one or more data mining systems, such as systems operated by commercial firms, advertisers, social or political analysts, etc., for use in making commercial offers, studies, and other analyses. The same and/or one or more further of the encrypted data records can represent one or more personally-identifiable data items, or types of data items the custodian wishes to authorize the data sharing management system to share with others, such as the at least one data mining system, in response to the request(s) for personally-identifiable information.

Before sharing any of the data identified requested by the data miner system(s), the data sharing management system can use at least one of the identifier(s) associated with the data custodian and the data representing the at least one transaction identifier to confirm that the transaction consent data set represents a valid consent for release of personally-identifiable information. Conditioned upon such verification, the data sharing management system can generate a transaction response data set, which can include, among other items, one or more data records representing the personally-identifiable data authorized by the custodian for communication to the at least one data mining system, and can route the transaction response data set to the at least one data mining system over the same or another electronic communications network.

In the same and further aspects and embodiments, data sharing management systems according to the invention can use time stamps in the processing of such consent data sets and cryptographic signatures. Such time stamps can, for example, comprise data representing either or both of a date and time at which a transaction consent data set was generated by the device from which it was received, and a cryptographic signature associated with the user entitled to authorize access. In such cases the data management sharing system can be configured to generate individual hashes of at least two of the data representing the cryptographic signature of the user entitled to authorize access; the data representing the date and time at which the transaction consent data set was generated by the user device; a date and time at which the transaction consent data set was received by the data sharing management system; and the request transaction identifier; and can store at least the individual hashes in a secure memory architecture.

In the same and other embodiments, security of the recordation of consents given by data custodians can be improved by time stamping times of generation and/or receipt of consent data sets; and hashing or otherwise encrypting combinations of data from consecutive sets of consent data relating to either or both of specific pools of data private or otherwise sensitive data, and individual data custodians.

Optionally, as explained herein, secure storage of consent data sets can include storing various forms of such data sets in either or both of secure private data storage and in permanent public ledgers (e.g., by using ‘blockchain’ type techniques).

In various aspects and embodiments the invention further provides data sharing management systems, and corresponding user devices 100, data mining systems 300, methods, and programming products, configured for controlling secure, verified access to data records representing personally-identifiable data over an electronic communications network, the data sharing management systems being configured to generate, using information received from one or more data mining systems over an electronic communications network, a specific transaction consent request data set. Such a specific transaction request data set comprising data records representing at least a specific consent request identifier uniquely associated with a specific data transaction request; a date and time at which the specific transaction request data set is generated by the data sharing management system; an identifier associated with at least one data mining system seeking private or otherwise sensitive data from end users such as data originators or custodians; one or more identifiers associated with a purpose of the specific data transaction request; a length of time for which a consent responsive to the specific data transaction request is requested to be valid; one or more identifiers associated with one or more types of requested data associated with the specific data transaction request; and one or more encryption identifiers associated with encryption algorithms to be used in encrypting the requested data. Using at least one algorithm associated with the one or more encryption identifiers, the data sharing management system can encrypt the specific transaction consent request data set, store both the unencrypted and encrypted specific transaction consent request data sets in secure memory controlled by the data sharing management system; and store the encrypted specific transaction consent request data set in a secure public data ledger.

The data sharing management system can further, via the same or another electronic communication system, route to at one least data custodian communication device signals representing the specific transaction consent request data set; and receive from the at least one data custodian communication device signals representing at least one specific transaction consent data set. Such a specific transaction consent data set can comprise encrypted data representing at least the specific consent request identifier; a signature representing authorization to generate the specific transaction consent data set; a date and time at which the specific transaction consent data set was generated; and at least one encryption identifier associated with an encryption algorithm used to encrypt at least a part of the specific transaction consent data set; store the specific transaction consent data set in secure memory controlled by the data sharing management system; and store the specific transaction consent data set in a secure public data ledger.

Such a data sharing management system can further be configured, subject to verification that the specific transaction consent data set represents a valid consent for release of personally-identifiable information, generate an encrypted specific consent recordation set, the encrypted specific consent recordation set comprising at least at least the specific transaction consent data set, and store the encrypted specific consent recordation set in a permanent public ledger, and subsequent to storage of the encrypted specific transaction consent data set in the permanent public ledger, generate a specific transaction response data set, the specific transaction response data set comprising at least one or more data records representing the personally-identifiable data authorized by the specific transaction consent data set for communication to the at least one data mining system, and route the specific transaction response data set to the at least one data mining system over the same or another electronic communications network.

In further aspects and embodiments, the invention provides data sharing management systems, data mining systems, and data originator or custodian network communications systems, and components thereof, in accordance with the various features and advantages described herein, and corresponding methods, processes, components, and programming structures, including coded machine-readable instruction sets stored in non-transitory media.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIG. 1A is a schematic block diagram showing an embodiment of a system or architecture 1000 suitable for use in implementing various aspects and embodiments of the invention.

FIG. 1B is a schematic diagram showing and examples of data flows between the various components of FIG. 1A, in accordance with such aspects and embodiments.

FIGS. 2A-2Y are schematic diagrams showing examples of interactive graphical user interfaces suitable for use in registering a data originator or custodian network communication device, and inputting profile data in accordance with various aspects and embodiments of the invention.

FIGS. 3A-3O are schematic diagrams showing examples of interactive graphical user interfaces suitable for use in setting parameters to be used in control of private or otherwise sensitive information in accordance with various aspects and embodiments of the invention.

FIGS. 4A-4D are schematic diagrams showing examples of interactive graphical user interfaces suitable for use controlling incentives provided to device users in accordance with various aspects and embodiments of the invention.

FIGS. 5 and 6 are schematic diagrams showing secure encrypted data sets in accordance with various aspects and embodiments of the invention.

### DESCRIPTION OF EMBODIMENTS

In various aspects, the present disclosure provides systems, devices, and persistently-stored, machine-readable computer program products for enabling the originators or custodians of potentially private or otherwise sensitive data to control access to, and sharing and/or other use of such data by others for social, economic, and other purposes, and optionally to benefit from doing so through the receipt of various types incentives.

For example, in various aspects and embodiments the invention provides systems, devices, methods, and persistently-stored, machine-interpretable programming and/or other data products for the generation, sharing, and storage of potentially private or otherwise sensitive data, and the generation and storage of secure, permanent records evidencing consents and authorizations given by originators and/or custodians of such data for the users to access and/or use and/or share the data for purposes approved by the originators or custodians.

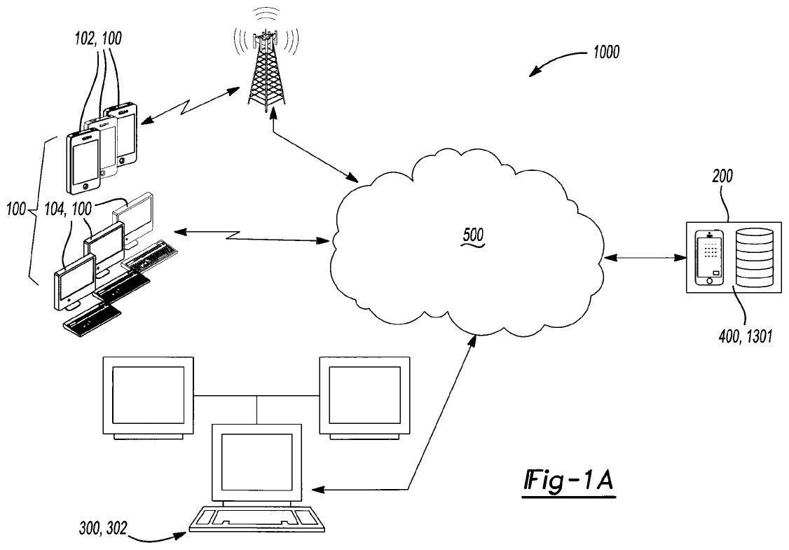

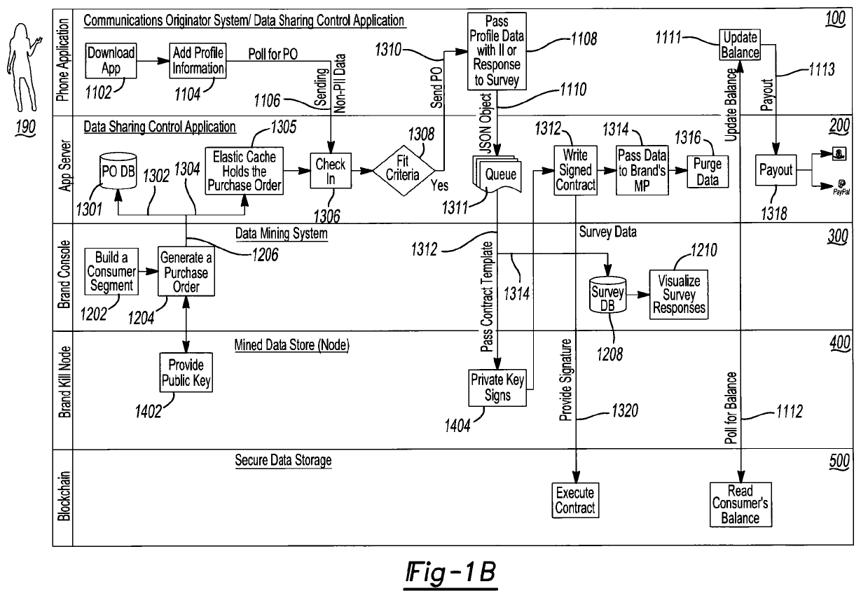

FIG. 1A is a schematic block diagram showing an embodiment of a system or architecture 1000 suitable for use in implementing aspects and embodiments of the invention. FIG. 1B is a schematic diagram showing examples of data flows between the various components of FIG. 1A, in accordance with such implementations.

In the embodiment shown in FIG. 1A, a data management and control system 1000 comprises one or more of each of originator, custodian, or other user network communication data devices (or systems) 100; data sharing management or control system(s) or server(s) 200; data mining system(s) 300; mined data storage node(s) 400, and network(s) 500.

As will be readily appreciated by those skilled in the relevant arts, each of components 100, 200, 300, 400, 500, etc., may be implemented using any electronic signal/data processors, such as smart phones and other mobile network communications systems 102, desktop or server-class networked stationary platforms 104, 302; volatile and/or persistent memory stores; together with other desired data or signal communications components; etc., suitable for configuration to accomplish the purposes disclosed herein, and they may be implemented in any numbers deemed suitable by those implementing such systems. They may each or all be communicatively linked using any suitable wireline or wireless communications systems, including any or all of any suitable radio, cellular telephone, public switched telephone, and local and/or wide-area network technologies and protocols, including for example the internet and IP protocols such as hypertext transfer protocol (HTTP).

Processes executed by any of the components 100, 200, 300, 400, 500 can be implemented through the use of digital signal processors executing stored instruction sets, operating in conjunction with one another through the use of suitably-configured signal communications networks and components. A wide variety of suitable means for implementing such processes are known, and doubtless they will continue to evolve. For example, either special-purpose or general-purpose, programmable data processors, executing compiled programs and applications written in any of a large number of suitable programming languages and stored in persistent memory, will serve, as will specially-designed processors in the form of hardware or firmware. Those skilled in the relevant arts will not be troubled by configuring automatic signal processors to execute the processes described herein.

As previously noted, FIG. 1B is a schematic diagram showing example data flows suitable for use by various embodiments of system(s) 1000 for data communications processes in accordance with the disclosure herein. Such processes are explained by way of the following examples.

In the example shown in FIG. 1B, a system 1000 comprising one or more of each of components 100, 200, 300, 400, 500 is used for the generation, control, administration, manipulation, storage, and other processing of data pertaining to public and private communications, and related authorizations and consents, over networked data communications systems.

As may be seen, in the embodiment shown in FIG. 1B, processes in accordance with the disclosure can be viewed as involving three primary data flow streams. Process(es) 1102-1113 can be initiated and otherwise controlled by communication data originator system(s) 100, which are also referred to herein as data custodian network communication system(s) or device(s) 100; process(es) 1302-1318 by one or more data management server(s) 200; and process(s) 1202-1206 by one or more data mining system(s) 300.

It will be noted in the following that in various embodiments of the invention various aspects of the storage and authorization of access to communications data by data mining system(s) 300 by through agency or brokerage of data sharing control system(s) 200 and generation of data and control of communications thereof by originator or custodian system(s) 100 can use common processes if or as desired, for example, for the sake of security and/or processing efficiency.

As shown in FIG. 1B, an example of a process 1100 for generating data useful in enabling an originator or custodian 190 to create and control access to and other processing of potentially private or otherwise sensitive data (an “access sharing control process”) can include downloading and initiation, or other invocation, of a data sharing control application 1102. Invocation of a suitably-configured control item (e.g. an interactive application icon displayed on a touchscreen display) associated with a data sharing control application 1102 (or “app”) can, for example, enable a consumer or other user 190 to download and/or start the app, and by following prompts generated by the app on a touchscreen or other output device of the user's device 100, 102 at 1104 generate data representing personal or otherwise sensitive information, as well as control data suitable for use in controlling access to such sensitive data by responding to a survey concerning demographics, interests, etc. associated with the user 190, or individual(s) or entity(ies) associated with the user 190, through a series of structured or otherwise suitably-configured user interfaces (UIs) 240; and selecting from a variety of access control options.

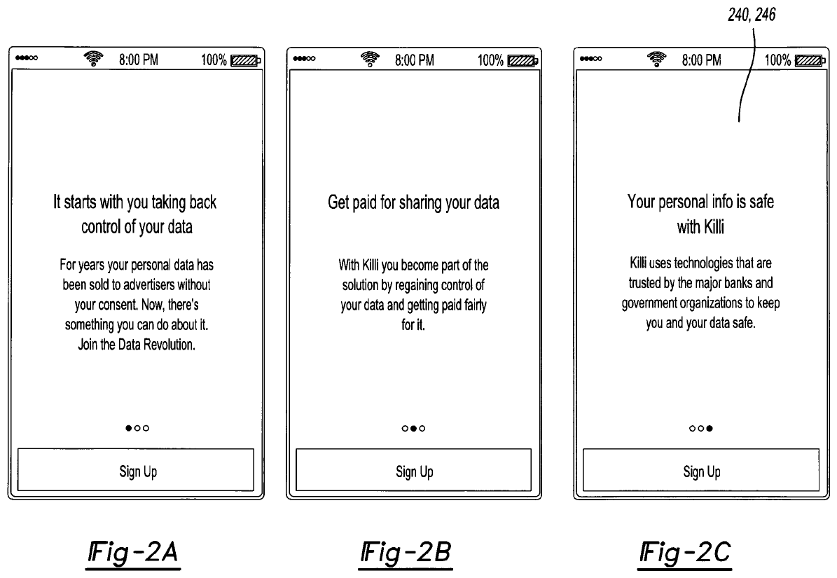

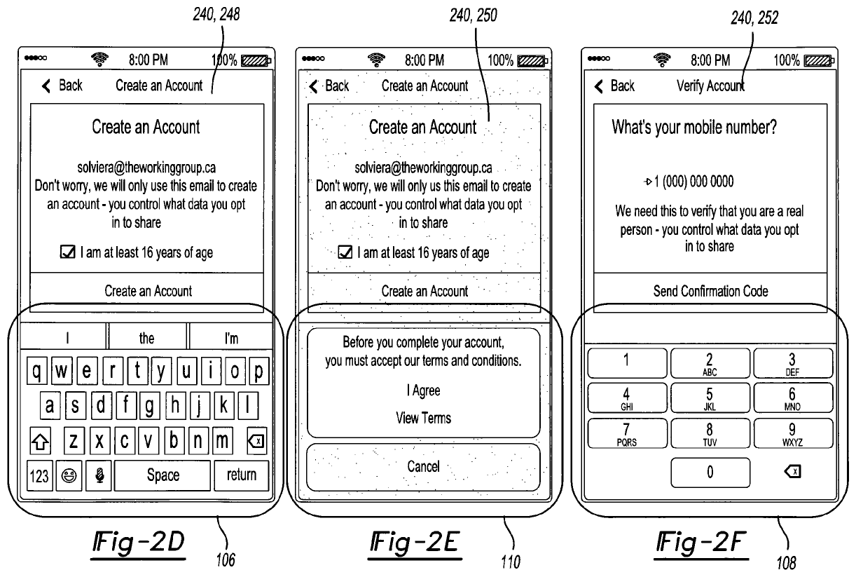

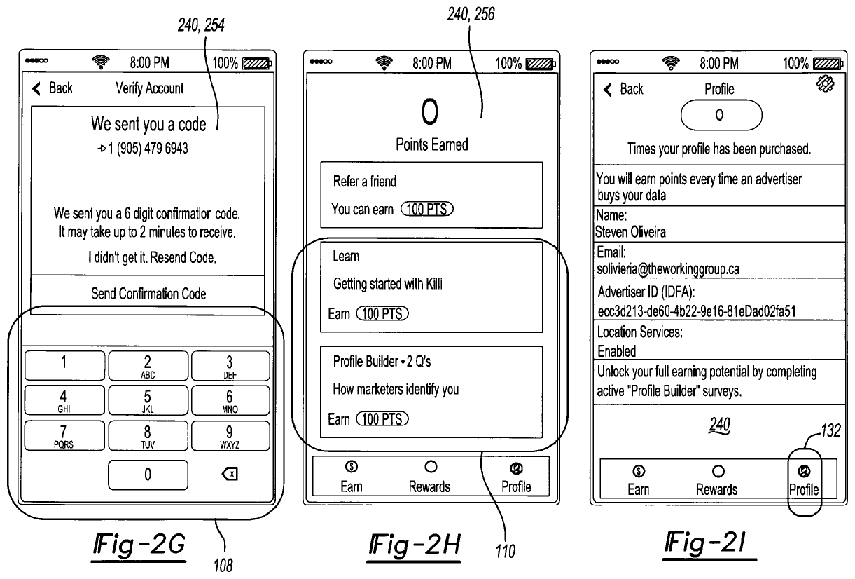

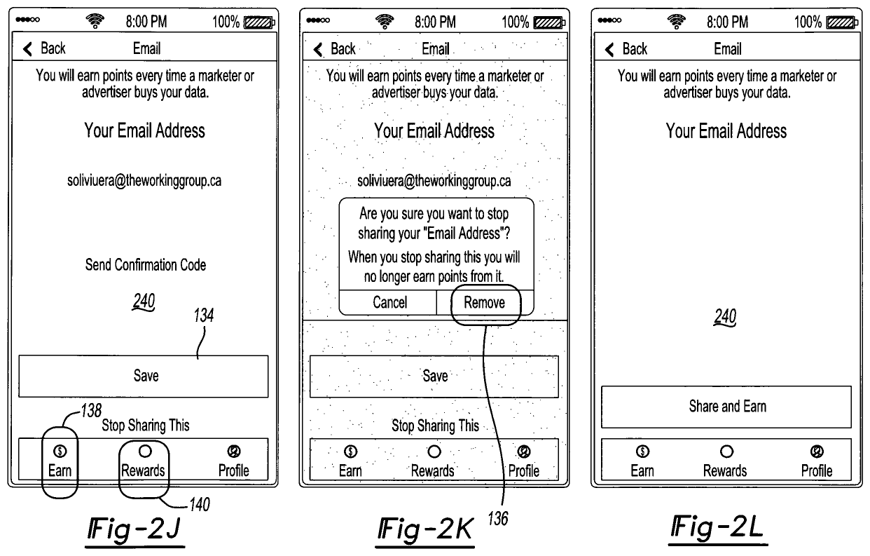

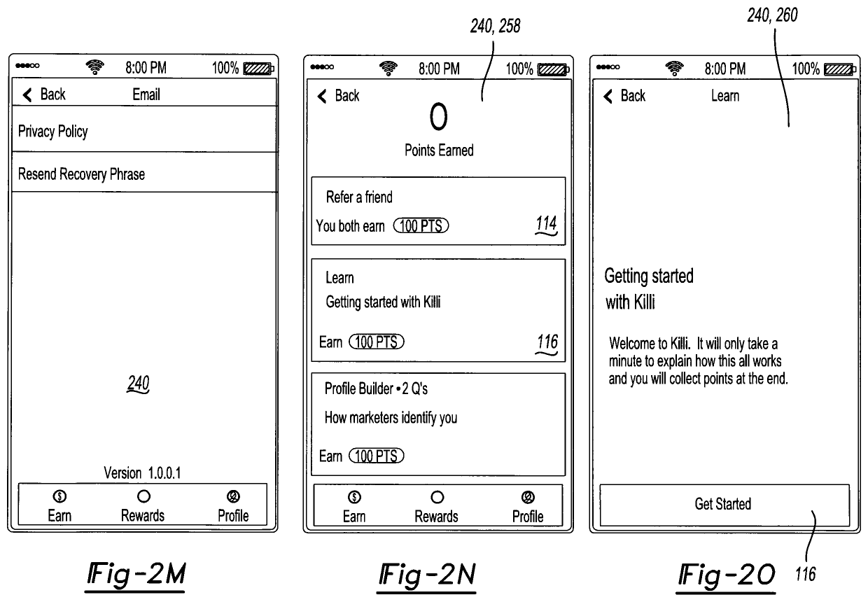

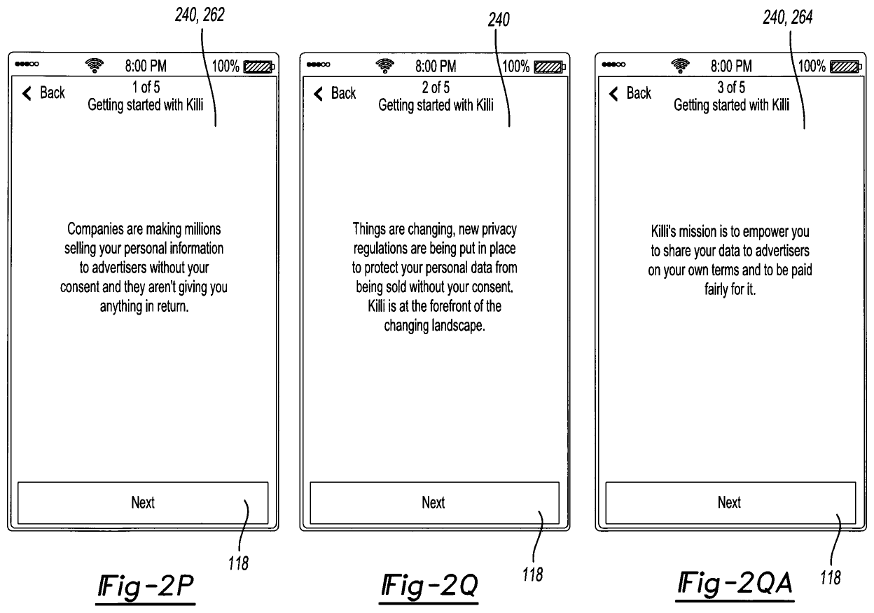

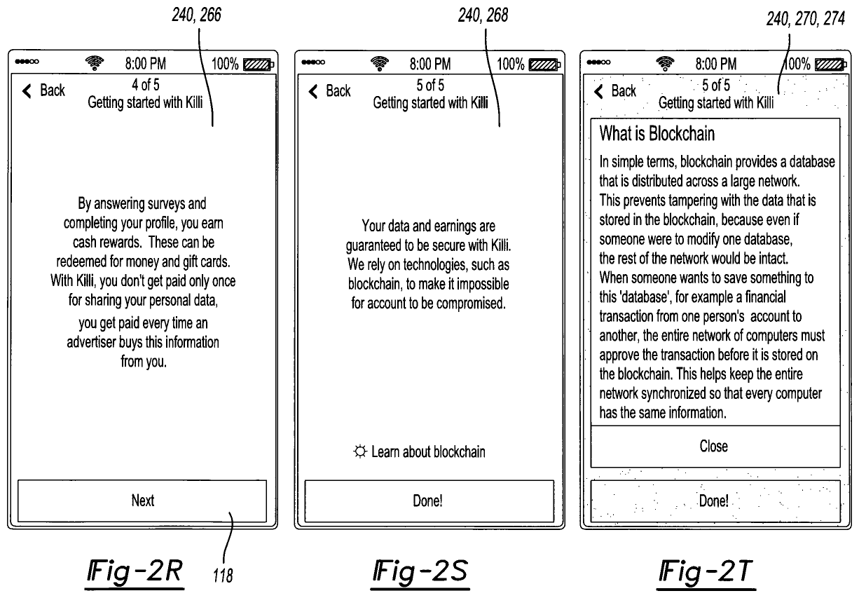

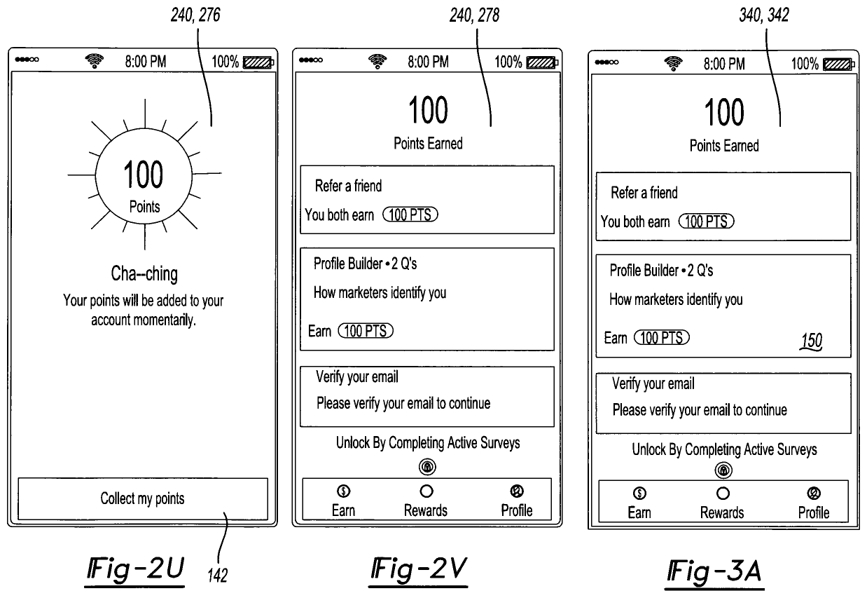

For example, as shown in FIGS. 1B and 2A-2H, at 1102 in FIG. 1B, a data custodian, data originator, or other user 190 of a network communication device can invoke a data sharing control application by for example selecting an interactive command item such as an application GUI device or a hyptertext address link on a promotional web page associated with a data sharing control system 200 and thereby starting an application download/installation process. With the download/installation process started, at 1104 a new user 190 of a device 100, 102 can be presented with a series of UIs such as those shown at 240-256 to download and install a data sharing control application and register with a corresponding server system 200.

As a first step, such a user 190 can be presented with and scroll or otherwise navigate through a series of display screens 2A-2C, adapted to present text introducing an application and explaining use and/or various advantages of controlling access to their private or otherwise personal data in through application, and to install the application on their smart phone, computer, or other network communications device 100.

Users 190 who have just downloaded a data sharing control application at 1102 can use a series of UIs 240, 248-256 such as those shown in FIGS. 2D-2H and one or more input devices such as virtual or physical keyboards 106, keypads 108, and/or command buttons 110 to provide information useful for setting up a profile or account, i.e., registering, for use by a data management system 200 in securely communicating with the user 190 about sharing or other control of access to data associated with the user 190 in accordance with the user's wishes. Such information can, for example, include e-mail addresses or account identifiers, telephone numbers, names, addresses, etc., as shown in FIGS. 2D-2H. All or some of such information can be used, in subsequent processes, as personally-identified information to be shared with data mining system(s) 300 through broker or data management system(s) 200, and in establishing and permanently and securely recording consents given for such purposes.

Once a new or returning user 190 has invoked a data sharing control application, and has entered basic profile information, the user can be offered a number of start-up options, as shown for example by UI 240, 258 in FIG. 2I. For example, a user 190 can be offered options of referring friends or other prospective new users 190, getting started for the first time, and/or creating or otherwise editing a user profile through the use of interactive command items 112, 114, 116 respectively.

As shown in FIGS. 2I-2Y, a user of a device 100 who has registered or otherwise established a profile with a server 200, etc., can access the profile to selectively control sharing of individual items or classes of data, or sets thereof. In the example shown, a user 190 can select a GUI command item 132 “Profile” to access her/his profile data, and can use a GUI command item 134 to generate a data set adapted to cause either or both of the associated data sharing control application and/or processes run on server 200 to flag one or more items or item types as private, or otherwise not to be shared with any marketers or other requestors (data mining system(s) 300), at any given time or time range, with sets, types, or classes of such requestors, or with individual, specifically-identified data miners, such as preferred marketers or vendors. Optionally, one or more GUI command item(s) 135, 136 can be used to enable the user 190 to either confirm or discontinue confirm her or his intention prior to flagging the data item(s). As shown in FIG. 2L, the fact that a data item has been flagged as private, or otherwise not to be shared in all or some conditions, can be confirmed by appropriately-configured GUI output devices 136. In the example shown, the fact that a user's e-mail address is not to be shared can be indicated by displaying a blank where an e-mail address might otherwise be displayed, although the user's e-mail address is in reality retained by the data sharing management system 200, for use in communications between the device 100 and system 200. Optionally the user can re-instate sharing of a command item (i.e., flag the item as appropriate for sharing under specified conditions) returning to a screen such as that shown and 2L by tapping or otherwise selecting the corresponding “cancel” input field 137 (e.g, by using a touchscreen), and if required entering or re-entering the desired data.

In similar fashion, user(s) 190 can invoke command items 138, 140 to invoke or otherwise control processes for accruing money or other value(s) as incentives for sharing his/her data.

Once a user has registered his/her identity and data sharing preferences and caused them to be stored locally on his/her device 190, and/or on a secure data sharing control server 200, the user can access a GUI 258 such as that shown in FIG. 20 and invoke a command item 114 “getting started.” Such invocation can, for example, initiate presentation of one or more UIs 240, 260-274 comprising overviews or other explanations of the process 1100 for controlling sharing of private data, and its advantages, as well as interactive UIs configured to elicit control and other data to be specified by the user 190 in enabling secure communications between the user's device 100 and one or more data control server(s) 300, optionally via data sharing management system(s) 200 concerning the user's private data.

Once a user 190 has been presented with, and optionally confirmed that she/he has read and understood, information confirming terms of an agreement whereby the user is entitled to cash or other value in return for sharing his/her private information, the user can be presented with a UI 240, 276 such as that shown in FIG. 2X, comprising an acceptance or confirmation command item 142, selection of which generates signals to configured to serve as acceptance by the user 190 of the agreement.

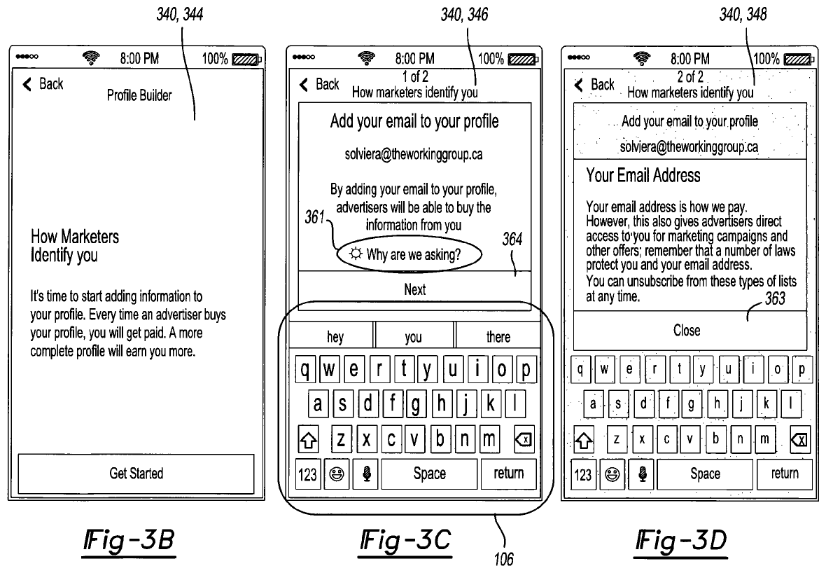

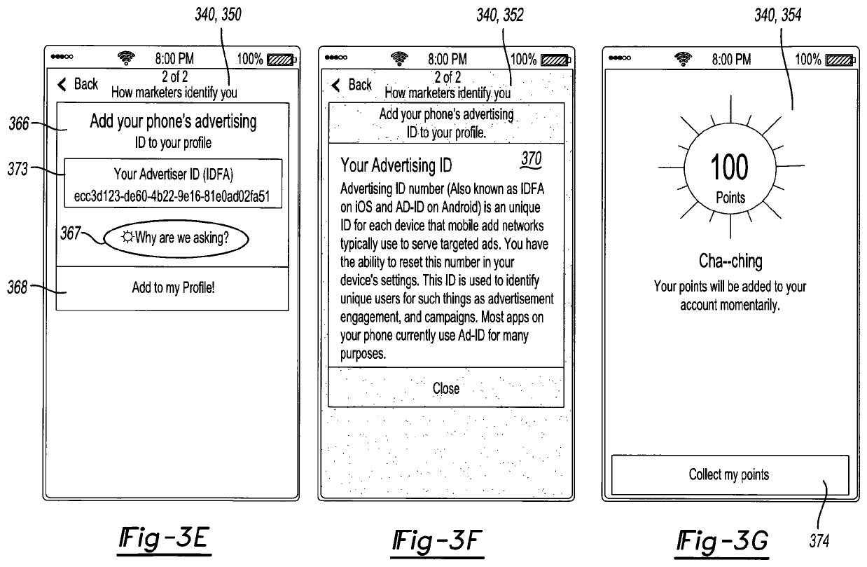

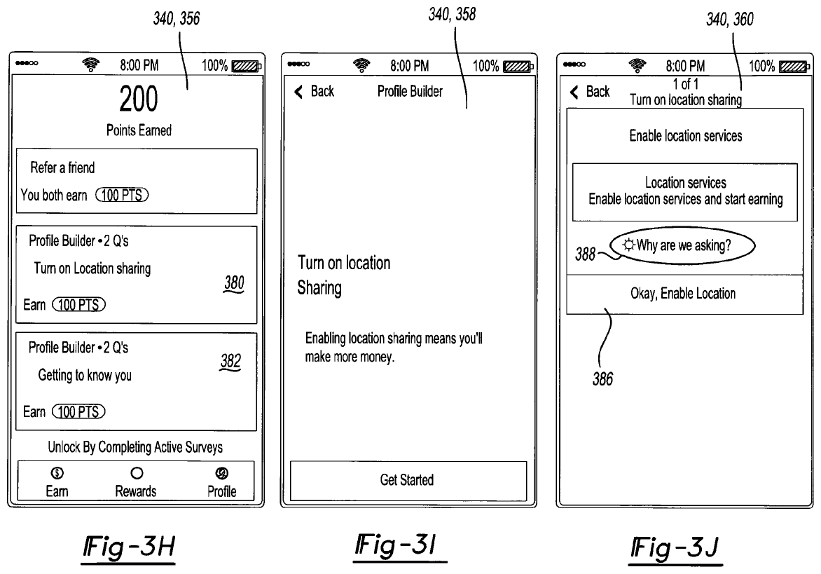

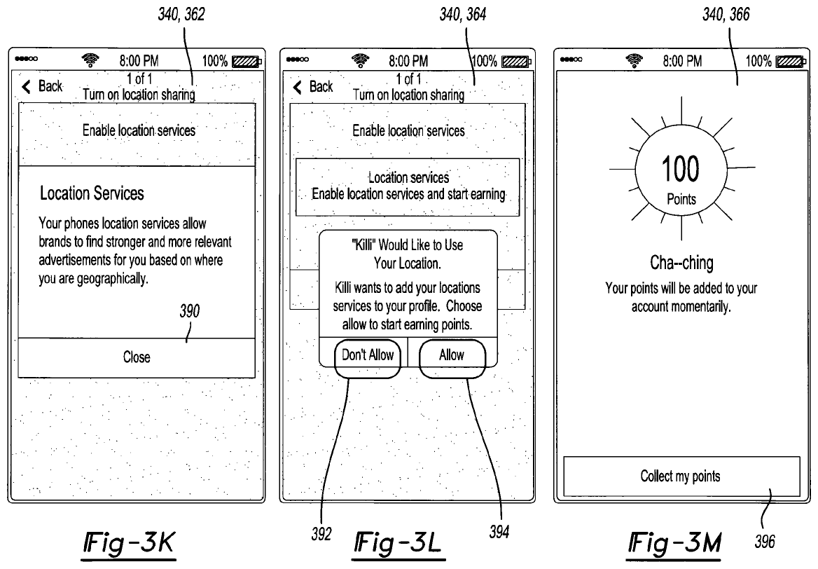

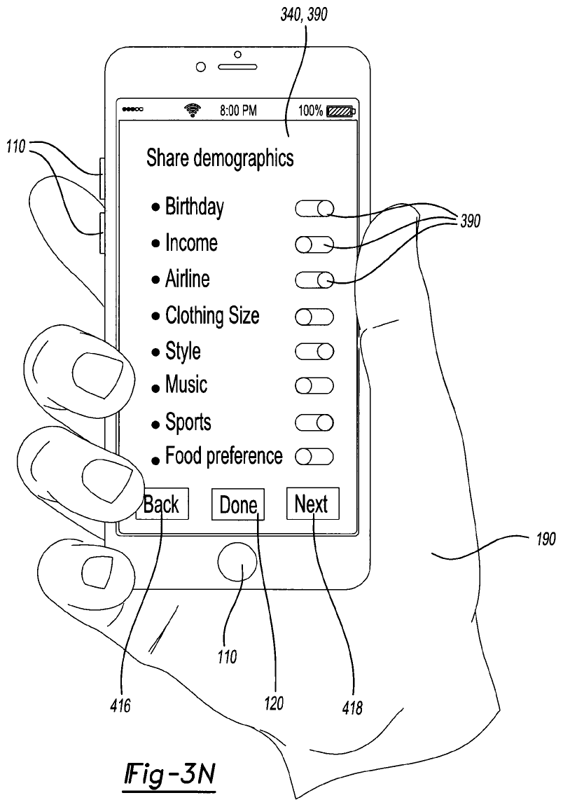

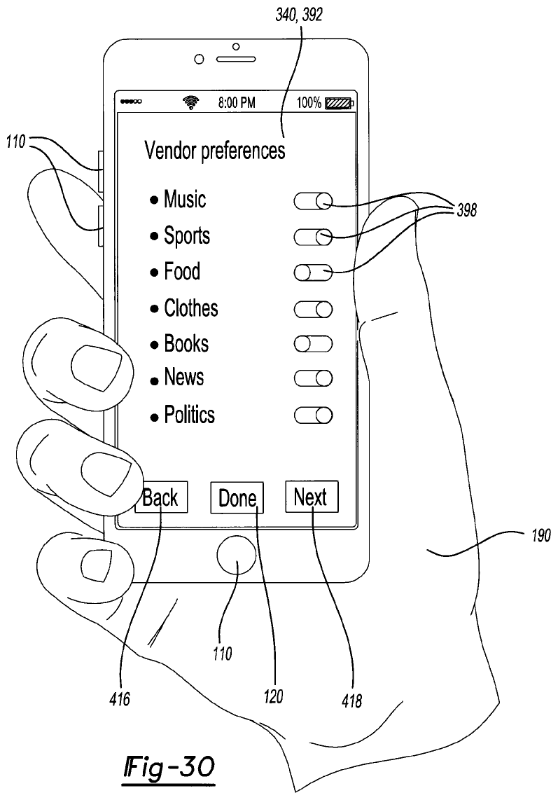

Process(es) 1104 of adding user profile information can also include generation of signals representing data (e.g., commands) configured for use in control of sharing of a user 190's personal data with one or more classes or types of other users, for example commercial or public interest advertisers, vendors, social contacts, etc. For example, as shown in FIGS. 3A-3G such a user 190 can be presented by a data sharing control application associated with her/his device 100 with a series of UI's 340, 342-354 adapted to elicit input of any of a wide variety of types forms.

For example, as shown in FIG. 3A, a user 190 can initiate such a process by selecting an interactive command item 150 “How marketers identify you”, and, after suitable further explanation, selecting a command item 152 “Get Started”.

Selection of a command item 152 can, for example, initiate a series of questions (e.g., a survey) adapted to poll the user 190 on various aspects of authorizing the sharing of her/his private information, or other personal or otherwise sensitive data for which the user is authorized to grant access (i.e., which is in such user's custody), including options that might result in earning of larger or smaller amounts of cash, rewards points, or other incentives.

For example, as a first step, as shown in FIG. 3C an originator, custodian, or other user 190 of private or otherwise sensitive data can be invited to share a class or type of such information associated with one or more preferred modes of communication for sharing with marketers or other users of private communications data. In the example shown, at 360 a UI 340, 346 can include an input/output item adapted to solicit a user 190 for authorization to sell or otherwise share access to one or more of the user's e-mail addresses. A user 190 who is inclined to assent can use a real or virtual keyboard, or other input device 106, to enter a desired e-mail address. If the user is curious as to why the e-mail address is wanted by advertisers, or what use might be authorized by allowing it to be provided, the user can select a command item 364 and thereby access an explanatory screen 363, as shown in FIG. 3D. Once the user has understood information presented at 348, the user can invoke a command item 363 “close” to return to the screen 346 of FIG. 3C, and either authorize use of the e-mail as proposed, or decline.

Invocation of a command item 364 “Next” from UI 340, 346 can result in display of a UI 340, 350, whereby the user 190 can be solicited to authorize sharing of one or more telephone numbers, physical addresses, etc. Use of items 366-372 in a manner analogous to that described above for items 360-364 can enable a user 190 to be invited at 366 to share a phone number or other item of personal information, to consider reasons 370 for doing so, and to authorize sharing at 368.

When the user has completed authorizing or declining to authorize a first type or class of data for sharing with marketers or other users, at 374 n FIG. 3G the user can so indicate; optionally the user can be awarded cash, cash equivalent, points, or other incentives for doing so, as shown in UI 354.

In various embodiments the user 190 can further be solicited to authorize sharing of one or more further classes of data, as shown for example in FIG. 3H. In the example shown, a UI 340, 356 presents one or more UI command items 380, adapted to enable a user 190 to authorize sharing of location data, as for example through use of mobile device GPS, cell locations, and other positioning methods; and 382, adapted to enable sharing of other types of data, as for example explained below. In each case, as may be seen, additional incentives “100 pts.” can be offered in return for either or both of such authorizations.

Selection or invocation of a command item 380 “Turn on location sharing” as shown in FIG. 3H can for example cause generation and display of a series of UIs 340, 358-366, comprising UI command items 384 adapted to enable a user 190 to start the location sharing process; 106 to enter data identifying one or more location services (e.g., GPS devices, mapping services etc.) to be used in providing shared location data; 388, 390 to explain reasons and options for sharing, and uses to be allowed; and 386 to enable such sharing and 392, 394 to either confirm or deny such sharing, as shown in FIGS. 31-3M. Item 396 of UI 366 of FIG. 3M can be used to initiate allocation of one or more rewards offered, for example, at FIG. 3H, to one or more accounts associated with the user 190 in exchange for such authorization.

Selection of a UI command item 382 “Getting to know you” can be used to generate a very wide variety of screens 340 adapted to solicit any desired form(s) or class(es) of further information. For example, as shown in FIGS. 3N, 3O, a user can be presented with UIs 340, 390, 392, comprising interactive survey elements 398 adapted to elicit or authorize sharing of identifiers, demographic data, preferences, etc., to be used by one or more data management server(s) 200 in selectively permitting access to the user's data by one or more data mining system(s) 300. Such information can, for example include:
Demographic data, such as:
   Age, birthdate
   Gender or gender preference
   Income
   Residence region or location
   Purchase preferences
   Food preferences
   Travel preferences
   Vehicle preferences
   Clothing size or preferences
   Style preferences
   Political or religious preferences
   Music preferences
   etc.
Preferences, such as
   Preferred vendors/solicitors or vendor/solicitor types
   Non-preferred (e.g., temporarily or permanently blocked) vendors/solicitors, or vendor/solicitor types
   Preferred contact methods, which can vary according to vendor(s) or vendor type(s); e.g., e-mail, telephone, social media
   Preferred contact types:
      Special offers
      Seasonal or other temporal preferences, e.g., time of day, day of week, etc.
      etc.

For example, use of command items 398 in the form of virtual sliding on/off buttons, as shown, can be used to authorize one or more data sharing control apps to allow collection and sharing of any of various forms of data associated with browser searches for food, clothing, and other items, or for addresses or other information associated with sources of such items, or browser searches for answers to related questions. Such information may have been previously entered, and/or selection of any of virtual buttons or sliders 398 can cause suitably-configured interfaces to be generated and displayed, in order to allow the user 190 to enter and/or occasionally update such information.

Command items 416, 418, etc. can be used to advance the process 1104 at the user's chosen pace and convenience.

As will be understood by those skilled in the relevant arts, a wide variety of interactive devices can be used for eliciting and collecting preferences, demographics, and other access control data. Such devices can, for example, include virtual survey tree structures, set (one-kind-suits-all) questionnaires, etc., and may be implemented in advance of designation of authorizations through the use of interfaces such as those shown in FIGS. 3N and 3O, or as a result of such designations.

When the user 190 is satisfied with the access control data input at 1104, the user can select a command icon 120 and thereby cause the entered data to be stored securely on the user's device 100, 102, 104. In some preferred embodiments of the invention, the user's access control data is stored only in a secure element on the user's device 100, or in other secure memory controlled only by the user 190. In other embodiments, such data may be retained, alternatively or in addition, in memory exclusively controlled by one or more data management server(s) 200, or in data accessible by both the user 190 and server(s) 200, as shown for example at 1106 in FIG. 1B. For example, an encrypted and/or otherwise secure data node 400 controlled by data sharing control system 200, or by a trusted third party may be used.

In the same and other embodiments, some or all user-provided access control data can be stored in encrypted and/or otherwise secure third-party memories 500, using for example block chain technologies. Alternatively, data related to the access control data, but not the access control data, can be stored in such third-party memories. In any such embodiments, a UI 240, 274 such as that shown in FIG. 2R can be used to inform the user 190.

Based on responses provided by a user 190 at process step 1104, in various embodiments a data sharing control server 200 or application executed on a user's device 100 can assign a score to the consumer, originator, custodian, or other user 190, for use in either or both of awarding rewards to users 190 for authorizing sharing of data, and/or for generating prices to be applied toward marketers and/or others who may wish to acquire shared data for use in promoting products or otherwise sharing information. In general, for example, a user 190 can be awarded more points, and a higher price set for sale of access to the user's data by a marketing system 300, in return for authorization of sharing of larger amounts or types of data, and/or for sharing of data which is of greater potential value. A wide variety of suitable systems and processes for assigning such scores and/or bestowing incentives are known, and others will doubtless be developed hereafter.

In various embodiments of the invention, data provided by a user 190 of a device 100 can be divided, assigned, or otherwise segmented into three basic categories, types, or classes: (1) user/authorized custodian address/contact info (cell number, e-mail address, etc.); (2) basic demographics, such as actual or approximate age, residence (on a non-specific or regional basis), optionally income brackets, and/or consumer score/data value parameters; and (3) information which might be useful in identify a specific individual, which is sometimes referred to as personally-identifiable information, or “PII”. PII can, for example, include data associated with a user's consumer interests or habits, preferences, buying patterns, and optionally income brackets or actual income, as well as information pertaining to home or business addresses, financial records or accounts, names, etc. Such information may be sorted or assigned into various classes by manual designation by a user 190, automatically, depending upon type associations associated by an application or program with specific information designations 390 (e.g., FIGS. 3N, 3O); and by association of such information with data representing suitably-configured flags in suitably-configured data records.

In such embodiments, when at 1104 a user 190 has completed entry of desired data, for example as described in connection with FIGS. 2A-3O, the user's data sharing control app can generate, or cause to be generated, one or more public and private keys to be associated with the user 190. The private key(s) can be used, to establish secure, encrypted communications between the user device 100 and the data sharing controller 200, as well as, in effect, to serve as the user's signature, or authorization, on an agreement enabling a data sharing control app or server 200 to sell and/or otherwise PII, and to utilize user basic contact and demographic data in doing so.

Having generated the public and private keys, at 1106 the user's data sharing control app can route the public key, along with non-personal contact and basic demographic information to a data sharing control server 200, for storage in secure data stores, such as secure data elements and/or block chain structures 500, which can in some embodiments be referred to also as mined data nodes 400. In some preferred embodiments, block chain storage is preferred.

At the same time, the user's data sharing control app can store the user's PII, along with both public and private keys and demographic data, in a secure data element, such as a secure data sharing control wallet associated with the users data sharing control app, on the user's device 100.

In some embodiments, which can be especially useful in protecting sensitive PII, the user's PII is stored only in memory controlled by the user's own device 100, for example in a wallet or other secure data element.

With the user's PII securely stored on the user's device 100, and/or elsewhere, one or more processes of matching advertisers or other potential miners 300 of information to consumers or other potential recipients of goods, services, or information associated with the user's PII can begin. Such processes can use either or both of push or pull technology. In some presently-preferred embodiments, a user's data sharing control app, working from the user's device 100, can begin a process of polling a data sharing control server 200 to see whether any merchants or others have requested data from users whose profiles match relevant aspects of desired information or sales targets. Such pull processes can be implemented on a periodic basis, and/or triggered by other events, including for example user actions in a browser on the user's smart phone or other device 100, such as a browser search, etc.

As will be appreciated by those skilled in the relevant arts, once they have been made familiar with this disclosure, among the many significant advantages offered by the invention is the ability to match merchants, governments, public interest and social organizations, and other miners 300 of communications data to users 190 who might be interested in goods/services/information provided by such entities in exchange for various types of incentives (including goodwill), while allowing the user(s) 190 to control access to their own private information, or to information of others for which they are authorized custodians, including particularly PII. By, for example, providing cash payments or other valuable rewards to such users in exchange for sharing their information, very powerful incentives for sharing of personal data, optionally under strictly controlled conditions, can be provided.

Accordingly, in many embodiments one of the many important aspects of the invention is to enable a merchant (“Brand”) or other miner 300 of data to generate data sets representing characteristics of users 190 to be targeted for delivery of promotions, news or other types of information, etc., and to use such data mining request data sets to generate inquiries that will result in identification of pools or corresponding users. Data mining request data sets can be generated by such data miners at 1202, 1204 through the use of survey-type UI “Console” structures such as those shown and described in connection with FIGS. 2A-3O, or by any other suitable means.

In general, in such embodiments, at 1206 data miners 300 provide to one or more data sharing control server(s) 200 data mining request data sets comprising data identifying themselves and characteristics of users 190 they would like to reach with promotions, news, and other information useful for identifying likely willing targets for the information they have to share.

In some embodiments, data mining request data sets generated at a 1204 and routed at 1206 can include authorizations for payment to one or more data sharing control servers 200 for data to be returned to the miner(s) 300 in response to their mining requests. Accordingly, such data mining request data sets can be referred to as Purchase Orders (POs).

Such POs, and other forms of data mining request data sets, can include one or more public keys associated with the requesting Brand, or other requesting miner 300, which keys can be used to ensure that cash or other incentives provided by the Brand or other miner 300 in return for user data set(s) is ultimately routed to devices 100 designated by or otherwise associated with the appropriate user(s) 190. For example, at 1204 data mining incentive data sets comprising such public keys and data representing values to be paid to such users can be generated by server(s) 300 and, at 1320, stored in mined data node(s) 500 for example using block chain techniques.

At 1206 the PO or other data mining request data set can be routed to one or more data sharing control server(s) 200, which at 1302 can store it in a database 1301 for accounting and other purposes, and can also route it, at 1304, to an “elastic cache” 1305 for polling of or by user or network communication devices 100 as described herein.

As noted above, at 1104, 1106 in FIG. 1B a data originator, authorized data custodian, or other user 190 of a device 110 who wishes, under controlled conditions, to make PII in his/her control available to one or more data miners 300, or classes or types of data miners 300, can generate and route to a data sharing control server 300 a PII availability data set, the PII availability data set comprising for example data representing non-PH contact information, basic demographic information, and a public key associated with the user 190 and/or device 100.

Generation and routing of such a PII availability data set can occur periodically, at one or more times set by the user 190 and/or data sharing control application, or upon occurrence of a triggering event on the user's device 100, such as use of various keywords in browser searches executed on the user's device 100.

At 1305-1306 the data sharing control server 200 to which the PII availability data set is routed can cause data comprised by the PII data set to be compared to any data mining request data sets stored in the elastic cache 1305. On identification of a suitable match in the data mining request and PII availability data sets, which suitability can be determined using, for example, any of a very wide variety of known data processing and comparison techniques, at 1308 the data sharing control server can generate a PII consent request data set and at 1310 route it to the user contact designated in the PII availability data set. Such a PII consent request data set can comprise a public key associated with the requesting data mining system 300, the corresponding data mining request data set, and any criteria associated with the data mining request data set.

At 1108, the data sharing control application of the user device 100 associated with the address to which the PII request data set has been routed can parse the PII request data set to extract some or all of the criteria associated with the data mining request data set, in order to confirm that the PII request conforms adequately with criteria generated or otherwise established by the user 190 at 1102, 1104. As will be appreciated by those skilled in the relevant arts, the adequacy of conformation required to establish a match in criteria can be determined using, for example, any of a very wide variety of known data processing and comparison techniques, based on requirements or preferences of any or all of the user 190, the data sharing management system 200, and/or the data mining server(s) 300. Conditioned upon such confirmation, at 1110 the user's data sharing control app can generate a PII response data set comprising data representing some or all of the user's responsive PII to be routed from the user's device, and/or from other secure data store, to a queue 1311 at the same or another data sharing control server 200.

PII represented by a user's PII response data set can be used for a variety of purposes. For example, in some embodiments of the invention, PII is routed for processing in at least three different ways. In such embodiments, for example, all or some of the PII can be routed, at 1314, to one or more data mining systems 300 whose mining requests match the user's PII, for storage in such mining systems' survey databases 1208. In such cases the stored PII can be used to analyze results of or design marketing surveys, consumer buying patterns, sales campaigns, news releases and reactions to news releases, etc.

At 1312, PII can be routed by the data sharing control server to a secure data storage facility, through for example the use of blockchain processes. As shown in FIG. 1B, at 1404 data stored in such fashion may be associated with the requesting data miner system 300's private key, and at 1312 tracked by the responsible data sharing control server 200 so that any incentives due to participating user(s) 190 are appropriately fulfilled. Records of any case payments or other award grants may be stored securely in blockchain or other memory at 1320.

As shown at 1314, if the PII has been returned to the control server 200 in response to a survey or other inquiry initiated by a data mining system 300, the control server 200 can store the PII temporarily, for review and forwarding to the requesting data mining system 300, for generation and/or acknowledgement of consents received from devices 100, and/or for further review and administration. Upon forwarding to the data mining system 300, at 1316 the PII can be deleted, in the interest of security and confidentiality.

As previously noted, an important aspect of responsibly sharing private or other potentially sensitive information via a communications network, particularly from the viewpoint of an information broker, i.e., a shared data management system 400, is the requirement for securely and retrievably recording evidence that the broker was authorized to share the data, in case any need to prove consent arises later.

Accordingly, in various aspects the invention provides systems, methods, and computer programming products for the generation and secure storage, reliable retrieval, and efficient updating of proof of sharing consents. The building of such proofs can be referred to as building a consent chain of custody.

A process of generating proof of sharing consent can be considered to begin, for example, with the generation of a public key/private key encryption pair associated with a data originator or custodian 190 and/or such user's smartphone or other network communications device, for example by a data sharing application operating on the user's device 100 as described in connection with reference 1104 of FIG. 1B. The key pair can be used to establish a secure connection between the user 190's device 100 and a data sharing management system 200, as shown for example in FIG. 1B, and can be associated with that user 190's account going forward, optionally as a unique identifier of an originator or authorized custodian of data associated with the account. As described above, the private key can stored in a secure memory element on securely on the device 100, for secure access by the user's data sharing application.

The public key can be sent to a data sharing control system 200 associated with the data sharing application, and stored on the system 200's servers, or under the server's control, for example in a memory 1402 as shown in FIG. 1B.

When the user 190 agrees to share their PII or other sensitive data with the data management server 200, or with a third-party data mining system 300, for example by using the data management server as a secure broker, the user's device 100 can route to the data sharing server 200 a data sharing consent bundle, which may be transaction specific, and may for example comprise data representing at least information identifying the authorized custodian 190, for example an “Advertiser ID” 373, 370 (see FIGS. 3E, 3F) address information associated with the custodian and/or her/his network communications device 100, either the specific information to be shared or one or more references to types or classes of information to be shared, and optionally an identifier associated with a specific request for data (a ‘transaction identifier’) received by the data sharing controller 200 from the data miner 300.

In some preferred embodiments, the data sharing consent bundle is electronically signed on behalf of the sharer 190, by means of the data sharing application on the user's device 100, by for example using the user's private key.

On receipt of such a sharing consent bundle, the data management server 200 can generate a consent record by, for example, accessing the encrypted data using the user's public key, generating forward hashes of (i) the PII that identifies the authorized custodian, or sharer, such as an email address and/or telephone number; (ii) the transaction identifier, and (iii) a bit array indicating what data stored by Killi the custodian has approved for sharing with the data miner 300, which can for example include any or all of one or more email addresses, telephone numbers, the transaction identifier, gender, date of birth, network address (e.g., IP address, URL, etc.) and physical location data, or other information described herein.

Alternatively, such hashes can be generated by a data sharing application on the user's device 100, and included in the sharing consent bundle routed to the data management server 200.

It can be particularly advantageous to include, in the consent record, either or both of a ‘time stamp’ comprising the date and time at which the authorized sharer 190 authorized the sharing, and date and time the consent bundle was received or processed by the data sharing management system 200. In such cases forward hashes of the time stamp(s) can be included in the bundle, along with the other data described above.

On receipt by the data sharing management system 200, the sharing consent bundle can then be verified in order to establish that the sharing permission is valid. For example, at 1308 in FIG. 1B the data sharing management system 200 can decrypt the sharing consent bundle by using the corresponding public key and compare the sharing user 190's electronic signature, or credentials; the data or types of data to be shared; and the transaction identifier; with user credentials and associated user PII data in memory(ies) 1301, 1401, and with transaction requests received from data mining system(s) 300, which may also be stored in memory(ies) 1301, 1401, in order to ensure that (a) the user is an authorized sharer or custodian of data to be shared, (b) the data, or types of data, to be shared, exist, and (c) that the consent matches an existing and active request for data from a data mining system.

Upon verifying that the sharing consent bundle is valid, the data sharing management system 200 can do at least two further things: (1) it can store a secure record of the consent in trusted memory; and (2) it can cause PII or other potentially sensitive data to be shared with the requesting data mining system(s) 300, in accordance with the terms of the consent.

To store a secure record in trusted memory, the data sharing management system can store the sharing consent bundle, or any portion(s) of it, including the forward-hashed information described above, in permanent internal archival memory such as a memory(ies) 1301; in controlled archival memory(ies) 1402; and/or in secure public ledgers 500. Such consents may be stored using data warehousing techniques, including for example through the use of fact tables and parameter dimensions, such as time dimensions.

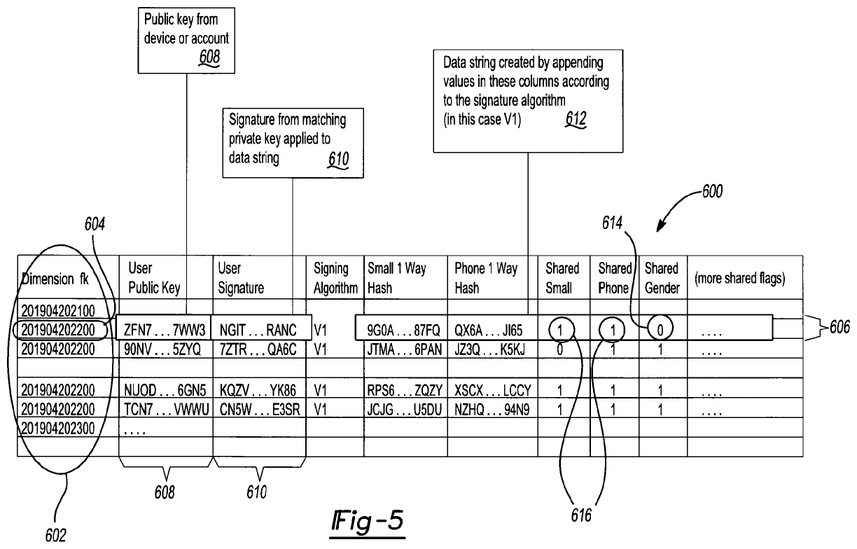

Such warehousing techniques and dimension tables can be used with particular advantage for the purpose of reliably establishing records of data sharing consents. For example, as shown in FIG. 5, a fact table 600 indexed in accordance with a time dimension 602 can be used to both establish a time 604 that a consent record 606 was recorded and/or to provide an efficient and convenient means for retrieving specific consents, in order to prove their validity later, in the case for example of use or regulatory inquiries.

In the example shown in FIG. 5, the fact table 600 comprises a number of records 606, consent record data set comprising a plurality of hashes representing personal data, including PII, associated with an authorized custodian or other sharer 608. In the example shown, each consent data record comprises hashes representing:
The user's identity and public key, at 608
The user's signature, at 610
A data string representing data items the user 190 has authorized to be shared, at 612.
   In the embodiment shown, the user whose public key has been hashed as EFH7 . . . has authorized sharing of an e-mail address, a telephone number, and other items, as indicated by use of the flag “1” at 616, and has not authorized sharing of his/her gender, as indicated by use of the flag “0” at 614. The use of flags in the consent record, rather than the corresponding PII itself, can protect the integrity of the user's data. When the data management system 200 shares the data with a requesting data mining system in accordance with a valid consent comprising flags or other hashes, the actual data may be retrieved from system 200 memory(ies) 1301, 1402, from a secure element in a user device 100, etc. In the example shown,

In the example shown, three separate hashes have been incorporated into the data sharing consent record 606: a hash representing the user's public key; a hash representing the user's signature; and a hash representing the user's e-mail and/or phone numbers. An advantage of the use of multiple hashes, and in particular at least three hashes, is a greatly reduced vulnerability of the hashing scheme, as a process of generating electronic signatures, to later attempts to compromise the validity of the signatures, particularly in the case of older hashing algorithms such as SHA-1, etc.

As previously indicated, the use of time stamps and other evidence of the time(s) at which consents are provided by custodians or other authorized sharers of data can provide significant advantages in cases when it proves necessary to establish that a consent was provided at a given point in time. For example, it can be useful for a data sharing management controller 200 to store consents in secure, trusted memories such as public ledgers and other third party memories, including distributed memory schemes, as well as their own memory archives, before routing requested data to authorized data mining systems 300.

A further advantage of using time stamps, particularly in time-dimensioned fact tables, is that multiple consent records can be archived conveniently, and efficiently, at lower monetary cost and with reduced memory requirements, by for example combining multiple consents, each generated, received or stored within a given period of time, by hashing individual components of the consents and archiving the combination hash.

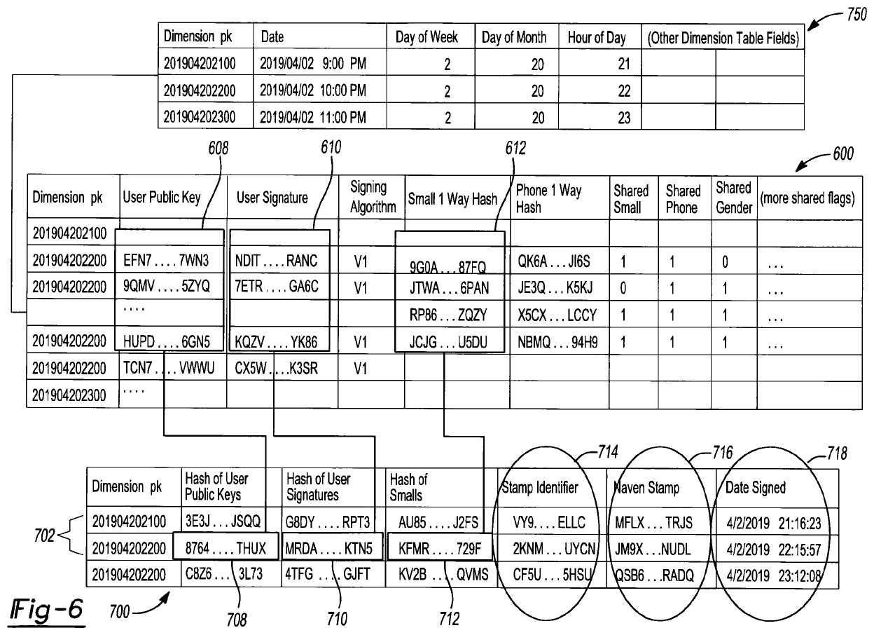

For example, as shown in FIG. 6, all records for a designated time period, such as within the one-hour which includes at least the four consent data records 606 illustrated in FIG. 5 can be accessed in sharing controller memory(ies) 1301, 1402, and hashed together, and a single combination consent data record 702 can be stored in a trusted public ledger 700 as well as the sharing controllers memory(ies). In the example shown, the four records 606 are stored in memory(ies) 1301, 1402 of the data sharing management system 200 in accordance with time parameters 750. In the example shown, each of the four records was generated by a different user device 100, and received by the system 200 within a single hour: the 21^{st} hour, or between 9 and 10 PM, of 2 Apr. 2019, and stored in the memory(ies) 1301, 1402 in fact table index or dimensioned by time.

In order to efficiently and reliably stored proof of consent for all of the records received during the priority period, including the four illustrated in the Figure, the system 200 can access the memory(ies) 1301, 1402, read all consent records 606 received by the system 200 within that hour between 9 and 10 PM on Apr. 2, 2019, and generate combined hashes of the four user public keys 608, the four user signatures 610, and the user PII 612, and store the resultant combined hashes 708, 710, 712 in a combined consent data record 702 in a trusted public ledger 700, and optionally in the system's own secure memory(ies) 1301, 1402. In addition to the combined hashes 708, 710, 712, the combined consent data record 702 can include hashes of time/date stamp identifier(s) 714, third party certification stamp(s) 716, and a non-hashed time stamp 718 indicating that the combined consent data record was received by the trusted public ledger at 57 seconds past 10:15 PM on the 2 Apr. 2019.

One of the advantages of using time stamps and time dimensions in such ways is that the size or range of time used for capturing groups of consent data records can be increased, or decreased, with relative ease; for example when a rate of consents is increasing, due to increased system use, the number of individual consents 606 used to generate combined records 702 can easily be decreased, in order to restrict the number of combined records represented by a single hash. This can, for example, be useful when combined hashes have to be backed out into individual data items, for example in order to verify a time/date/content of a consent, by reducing the number of de-hashing and lookup operations required in order to retrieve desired information. Time ranges used for such purposes can be set at any desired value, depending upon the number of consent data records to be processed and the amount of storage available, in addition to the rate at which consents are received. For example, combined records can be generated and stored daily, hourly, by the minute, or by the second, or fraction of a second.

In various aspects and embodiments, servers/systems 200 can use hash protocols such as Secure Hash Algorithm 256 (SHA256) in order to maximize security with reasonable processing efficiency. As noted in the Figures, such protocols can be used to hash some or all of the sharing consent signatures 610, the sharing consent share dates and times 612, and the sharing consent advertising id (transaction identifier(s)), and the hashes can be stored in a proof of point in time hashes fact table in the system 200's data warehouse 1301, as well as one or more public ledgers 500. This can, among other advantages, provide proof of immutability of the sharing consent fact table. The data cannot be modified after registration in the public ledger without invalidating both the consent signature and the point in time hashes.

Time is of the essence as the proof of point in time is only valid, in some regulatory or other administrative contexts, if the proof signatures stored in trusted memory such as a public ledger are updated before the consent signatures are used to share the personal data with requesting data miner(s) 300. In addition, it can be important to create the public ledger entries within a reasonable time of the end of the matching or verification process, in accordance with applicable administrative and regulatory requirements.

Thus, in various aspects and embodiments the invention provides data sharing management systems 200, and corresponding user devices 100, data mining systems 300, methods, and persistent, machine-readable program products, configured for controlling secure, verified access to data records representing personally-identifiable data over an electronic communications network. Such systems 200, methods, and programming products can be configured, for example to receive, from a plurality of user devices 100 by means of an electronic communications network, signals representing a plurality of transaction consent data sets, each transaction consent data set comprising a plurality of encrypted data records; at least one of said encrypted data records representing at least one identifier such as a unique number 373, 370, email address, or other unique identifier associated with an authorized data custodian 190, the same or at least one other of said encrypted data records further representing at least one request transaction identifier associated with a request for personally-identifiable information received by the data sharing management system from at least one data mining system; and the same or at least one further of the encrypted data records representing personally-identifiable data authorized by the custodian 190 to be communicated to the at least one data mining system 300 in response to the request for personally-identifiable information.

Using the at least one identifier associated with the authorized data custodian 190 and the data representing the at least one transaction identifier, the system 200 can determine whether the transaction consent data set represents a valid consent for release of personally-identifiable information. Conditioned upon such verification, the system 200 can generate a transaction response data set, the transaction response data set comprising at least one or more data records representing the personally-identifiable data authorized by the custodian for communication to the at least one data mining system; and route the transaction response data set to the one or more data mining systems 300 that requested it over the same or another electronic communications network.

In establishing reliable records of such consents, such data sharing management systems 200 can be configured to receive from the user's network communication device, in addition to the foregoing, data representing a date and time at which each transaction consent data set was generated by a corresponding user device 100 from which it was received, and a cryptographic or otherwise unique or unknowable signature associated with the authorized data custodian; and the to store in a secure memory architecture individual hashes of two or more of the data representing the cryptographic signature of the authorized data custodian; the data representing the date and time at which the transaction consent data set was generated by the user device; a date and time at which the transaction consent data set was received by the data sharing management system; and the request transaction identifier. In some preferred embodiments, the individual hashes are stored in the secure memory architecture in accordance with a time dimension, in a permanent public data ledger, prior to the routing of the transaction response data set to the at least one data mining system.

It may further be seen that in various aspects and embodiments the invention provides data sharing management systems 200, and corresponding user devices 100, data mining systems 300, methods, and persistent, machine-readable program products, configured for controlling secure, verified access to data records representing personally-identifiable data over an electronic communications network, such data sharing management systems 200 being configured to receive, by means of electronic communications networks, from one or more network communication devices 100, signals representing plurality of transaction consent data sets, each of the transaction consent data set comprising a plurality of data records, which can for example include data records representing one or more of the following: identifier(s), including PII and or data records 373, 370, associated with an authorized data custodian 190; transaction identifier(s) associated with requests for PII received by the data sharing management system 200 from one or more data mining systems 300; personally-identifiable data authorized by the custodian(s) 190 to be communicated to the data mining system(s) in response to the request(s) for personally-identifiable information; date(s) and time(s) (e.g., ‘time stamps’) at which the transaction consent data set was generated by the user device from which it was received, and cryptographic signature(s) uniquely associated with the authorized data custodian(s). Such a data sharing management server 200 can, for example, verify that each of the received transaction consent data sets represents a valid consent for release of personally-identifiable information to the corresponding at least one data mining system, and, with respect to each verified consent data set, generate individual hashes of at least two of: the data representing the cryptographic signature of the authorized data custodian 190; the data representing the date and time at which the verified transaction consent data set was generated by the corresponding network communication device; a date and time at which the verified transaction consent data set was received by the data sharing management system; and the request transaction identifier.

Using at least the corresponding individual hashes, such a system 200 can generate a plurality of encrypted verified data-sharing consent records, and store the plurality of encrypted verified data-sharing records in a secure memory architecture. Optionally, and in some applications preferably, such verified encrypted data-sharing consent records can be stored in a secure memory architecture in accordance with a time dimension, based on at least one of: the date and time at which the corresponding transaction consent data set was generated by the user device from which it was received, and the date and time at which the corresponding verified transaction consent data set was received by the data sharing management system.

In addition, such data sharing management systems can be configured to access, in the secure memory architecture(s), a plurality of verified encrypted data-sharing consent records stored in the secure memory architecture(s) within a specified—and selectable—time range; to generate, using a plurality of the individual hashes of each of the encrypted verified data-sharing consent records, a combined encrypted verified data-sharing consent record; and store the combined encrypted verified data-sharing consent records in the same or another secure memory architecture in accordance with a time dimension, based on one or more of the times at which the underlying consents were generated by device(s) 100, received by device(s) 200, and/or stored in the secure memory architectures.

Such data sharing management systems 200 can further be configured, conditioned upon the verification that each of the plurality of received transaction consent data sets represents a valid consent for release of personally-identifiable information to a corresponding at least one data mining system; to route to the corresponding at least one data mining system a transaction response data set, the transaction response data set comprising at least one or more data records representing personally-identifiable data authorized for sharing by the corresponding data custodian.

As previously noted, it can be important, in some applications, that a data sharing management system 200 according to such aspects and embodiments be configured to store the verified encrypted data-sharing consent record in the secure memory architecture prior to routing the transaction response data set to the corresponding at least one data mining system.

In further embodiments, the invention can provide systems, devices, methods, and programming products as described above, configured to provide traceable consent chains of custody by iteratively combining and storing consent data records. Such data management communications systems can, for example, allow simplified methods of tracing back all consents given by a distinct PII originator, custodian, or other sharer 190, by starting with a single, latest sharing consent record. For example, the invention provides, in various embodiments, data sharing management systems 200, configured for controlling secure, verified access to data records representing personally-identifiable data over an electronic communications network, the data sharing management system by receiving, receive, by means of an electronic communications network, signals representing a first transaction consent data set, the first transaction consent data set comprising a plurality of data records, the plurality of data records representing: at least one identifier associated with an authorized data custodian, at least one request transaction identifier associated with a request for personally-identifiable information received by the data sharing management system from at least one data mining system; personally-identifiable data authorized by the custodian to be communicated to the at least one data mining system in response to the request for personally-identifiable information; a date and time at which the transaction consent data set was generated by the user device from which it was received, and a cryptographic signature associated with the authorized data custodian. Conditioned upon verification that the first transaction consent data set represents a valid consent for release of personally-identifiable information, such systems 200 can generate individual hashes of at least two of the data representing the cryptographic signature of the authorized data custodian; the data representing the date and time at which the transaction consent data set was generated by the user device; a date and time at which the transaction consent data set was received by the data sharing management system; and the request transaction identifier, and store at least the individual hashes in a secure memory architecture.

Thereafter, such data sharing management systems 200 can receive further, i.e., second or subsequent, transaction consent data sets, such second transaction consent data set comprising a plurality of data records drawn from a same or similar pool of data types, i.e., one or more identifier(s) associated with the same or another authorized data custodian 190, at least one request transaction identifier associated with the same or another request for personally-identifiable information received by the data sharing management system from at least one data mining system; such personally-identifiable data authorized by the custodian to be communicated to the at least one data mining system in response to the same or other request for personally-identifiable information; a date and time at which the second or subsequent transaction consent data set was generated by the user device from which it was received, and the same or another cryptographic signature associated with the authorized data custodian. Conditioned upon verification that the second transaction consent data set represents a valid consent for release of personally-identifiable information, the system 200 can generate an encrypted data-sharing consent record using comprising at least a portion of the first transaction consent data set and at least a portion of the second transaction consent data set, and optionally route a responsive data set to the requesting data miner(s) 300.

For example, in such configurations two or more sequential consents issued by a single custodian or user 190 can be hashed as described in connection with FIG. 6, to form a combined consent data set, and stored in association with a user index, a time index, or both, for rapid and convenient retrieval, with subsequent hash-table look-ups providing multiple time stamps indicating when sequential consents were given.

As with other embodiments of the invention, such combined consent data sets can be stored in either or both of secure memories controlled by the system 200 and trusted third-party memories, such as public ledgers.

If at a later point in time verification of an earlier-recorded consent is required, verification can be accomplished in two primary steps. If necessary, the corresponding the combined sharing consent record 702 can be retrieved from secure memory in either data sharing management system 200's memory 1301, 1402, and/or from a trusted public ledger 500, and de-bundled by reversing hashes of, for example, the combined users' public key hash 608, the combined users' signature hash 610, and the combined users' PII has through otherwise-conventional hash table lookup procedures, the corresponding sharing consent record 606 can be retrieved from secure archival memory in either data sharing management system 200's memory 1301, 1402, and/or from a trusted public ledger 500.

As a first step in verification, signatures and hashes can be confirmed. First, each individual proof of sharing consent can be confirmed by validating that the consent was signed with the private key of the end user using the local copy of the public key of the user, stored by the data sharing management system 200 in secure memory, such as either or both of 1301, 1402. For example, the user 190's public key, having been stored as described above, can be retrieved by the data sharing management system 200 and used to interpret and confirm the content of the consent data record 606, by for example confirming that the name of a user 190 backed out of a hash table using the user's public key matches the name associated with the public key in the user's profile.

In addition, the step of verifying hashes and signatures can include validating other sharing consents bundled or combined with the consent to be verified, as described in conjunction with FIG. 6.

The step of confirming hashes against public keys can provide one or more time/date stamps 718 associated with generation, receipt, or storage of the consent data record, which in turn can be used to look up record(s) 606, 702 in separate secure storage, such as a public ledger or secure archive 1301, 1302, in order to compare data crossed referenced by hashes stored in separate databases. This process, which can be referred to as proof of registration, can be particularly useful when one of the secure memories is a trusted memory such as a public ledger.

The use of such processes can allow any data receiver 200 to prove that any single PII data received was shared with valid consent of an authorized originator or custodian 190.

Among the many advantages offered by such aspects of the invention is the ability to expand the signing algorithm described to include generation of hashes relating to other types or classes of PII, including for example age, geographic location, purchasing preferences, style preferences, etc., so that consents can be recorded without needing to replace or significantly re-engineer new data tables, since each sharing consent has its signing algorithm embedded in the signature.

In some applications, it can be advantageous to track consents granted by users 190 in connection with specific purposes. Thus, for example, if a later release of information by a data sharing control system 200 is questioned, the system 200 operators can cite a specific purpose cited by a user 190, and thereby justify the release.

For such purposes, the systems 200 and related processes and programming products can, for example, be configured be configured to receive special purpose consents (SPCs) generated by data sharing applications of user devices 100, or to generate, based on data provide from such devices, specific purpose consent requests (SPCRs) comprising data referencing or otherwise representing at least some or all of:
A request identifier unique to the SPC or SPCR being generated;
A title of or purpose for the data consent request
The entity that is authorized to receive the shared data (e.g., a brand, advertiser, or other data miner 300)
A text explanation of authorized use(s) of the shared data
A length of time during which use of the data is authorized, and/or an expiration date/time to be associated with the consent granted
A length of time during which storage of the data is authorized, and/or an expiration date/time to be associated with storage of the shared data, regardless of the time or length of time within which the data may be used
Text or other responses or representations related to any other regulatory or contractual requirements
Identifier(s) of hashing algorithm(s) used

If generated by a data sharing management system, the SPCR can be routed to one or more network communication device for acceptance or verification, as discussed below and returned to the requesting system(s) 200. Upon receipt of such verifications, the SPCR can and any corresponding hashes can be stored in a permanent data warehouse 1301, 1402 associated with the system 200, for example as described in connection with FIG. 5 above.

If generated by a user's network communication device 100, a special purpose consent (SPCR) can be verified as pertaining to valid and appropriate users 190 and data requests, as described above, and can be stored, along with any desired hashes, in a permanent data warehouse 1301, 1402 associated with the system 200, for example, as described in connection with FIG. 5 above.

Any desired hashes of all or any parts of such SPCs and/or SPCRs, such as any of hashes of any of the data records described above, can be published or otherwise stored on an the immutable public ledger, for example, as described in connection with FIG. 6 above.

In cases in which the SPCR is routed to a custodian or other user 190 for verification, the user 190 can registers her/his/its consent and create an SPC by, for example signing and SPCR data set with a private key. Alternatively, such a user can add new parameters, including any of the parameters described above, and routing it to the requesting data management system 200 as a new SPC.

An SPC, whether originating in response to an SPCR generated by a data sharing management system 200 or as an unsolicited SPC by a data sharing application of a user's device 100, can be signed by generating a signed SPC data set comprising data representing at least any or all of the following:
A request identifier unique to the SPC being generated, and/or to an SPCR received from a system 200, or both;
A private key signature of the relevant sharing consent;
A date and time at which the signed SPC is generated;
The signature algorithm(s) used to generate the signed SPC

The signed SPC can be routed by the user's data sharing app to the corresponding data sharing management system, for generation of request or response data sets as described above, and storing in accordance with any of the processes described above.

In some embodiments, it is advantageous to store signed SPCs and/or SPCRs in data fact tables dimensioned by date/time, as described above, for example as described in connection with FIGS. 5 and 6, and optionally dimensioned by either or both of the unique SPC and SPCR numbers as well. Before data is shared with any corresponding data mining system(s) 300 a final roll-up has of all shared SPC data can be generated, and stored in a trusted public leger, as described above.

It may be seen, from the foregoing, that in various aspects and embodiments the invention provides data sharing management systems 200, and corresponding network communication devices 100, methods, and computer programming products, for generating, verifying, and reliably and efficiently recording specific purpose consents (SPCs) and specific purpose consent requests (SPCRs) configured to generate, using information received from one or more data mining systems over an electronic communications network, a specific transaction consent request data set, the specific transaction request data set comprising data records representing at least a specific consent request identifier uniquely associated with a specific data transaction request; a date and time at which the specific transaction request data set is generated; an identifier associated with at least one data mining system; an identifier associated with a purpose of the specific data transaction request; a length of time for which a consent responsive to the specific data transaction request is requested to be valid; one or more identifiers associated with one or more types of requested data associated with the specific data transaction request; and one or more encryption identifiers associated with encryption algorithms to be used in encrypting the requested data. Using at least one algorithm associated with the one or more encryption identifiers, such systems 200 can encrypt the specific transaction consent request data set, and thereafter store the specific transaction consent request data set and the encrypted specific transaction consent request data set in secure memory 1301, 1402, controlled by the data sharing management system 200; store the encrypted specific transaction consent request data set in a secure public data ledger; using the same or another electronic communication system, route to at one least data custodian communication device 100 signals representing the specific transaction consent request data set; receive from the at least one data custodian communication device 100 signals representing at least one specific transaction consent data set, the specific transaction consent data set comprising encrypted data representing at least the specific consent request identifier; a signature representing authorization to generate the specific transaction consent data set; a date and time at which the specific transaction consent data set was generated; and at least one encryption identifier associated with an encryption algorithm used to encrypt at least a part of the specific transaction consent data set. The specific transaction consent data set can be stored in secure memory 1301, 1402 controlled by the data sharing management system; and the specific transaction consent data set can be stored in a secure public data ledger.

Such data sharing management systems 200 can further be configured to, conditioned upon verification that a specific transaction consent data set represents a valid consent for release of personally-identifiable information, generate an encrypted specific consent recordation set, the encrypted specific consent recordation set comprising at least at least the specific transaction consent data set, and store the encrypted specific consent recordation set in a permanent public ledger; and, subsequent to storing the encrypted specific transaction consent data set in the permanent public ledger, generate a specific transaction response data set, the specific transaction response data set comprising at least one or more data records representing the personally-identifiable data authorized by the specific transaction consent data set for communication to the at least one data mining system; and route the specific transaction response data set to the at least one data mining system 300 over the same or another electronic communications network.

As previously noted, data sharing controllers 200, on their own behalf and/or as agents or otherwise on behalf of data mining system(s) 300, can utilize a wide variety of incentives to encourage users 190 to share PII under safe and carefully controlled conditions. In such ways, for example, controllers 200 can help both merchants and other data miners 300 and users 190.

For example, a data miner 300 can offer or otherwise agree to pay cash or otherwise incentivize either or both of a user 190 and a sharing controller 200 in return for sharing of PII relevant to activities of concern to the data miner 300. Likewise, a controller 200 that has accepted an agreement for such incentives can on its own initiative offer to pass some or all of the incentives it may have received on to users who may have control of PII that is of interest to miners 300. In any or all such cases, at 1320 data representing such agreements can be stored securely in third-party data storage systems, using for example blockchain processes, in the form of PII agreement or contract data sets, or templates.

Such PII agreement data sets can include some or all of:
One or more identifiers associated with the requesting data miner 300
Responsive PII data sets, and/or references thereto. Where more than one user 190 has agreed to share PII, each response PII data set can be stored in conjunction with a distinct public key, and/or other identifiers, associated with the corresponding user 190. These can include payment or other account identifiers to be used in routing incentives to responding users.
Identifiers corresponding to unique references assigned by the responsible data sharing controller 300
Data representing agreed data sharing terms, including data, or types of data, to be shared, and incentives to be paid to responding user(s) 190.

According to various embodiments of such aspects of the invention, at 1111 a consumer or other user who 190 wishes to check on cash balances or other incentive values due to them under the terms of such agreements can automatically or manually initiate request(s) to update balances due and payments. At 1112, for example, a balance request data set can be generated by the user's data sharing control application and used to access blockchain or other records of corresponding agreements, account values, etc. Upon determining that such a user is due for payment or other reward transfer(s), at 1113 the user's data sharing control app can route to the responsible data sharing controller 200, or to another responsible controller, a payment request data set, which at 1318 can be processed by the responsible server 200 and used to cause payment or other transfer to one or more accounts or other data storage devices designated by or otherwise associated with the user 190.

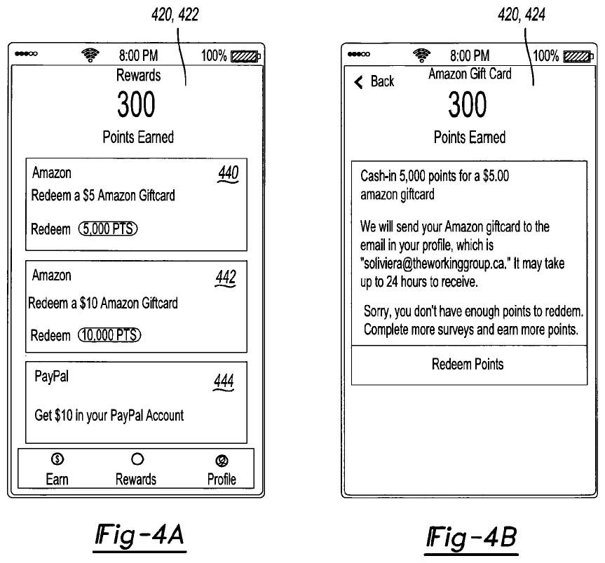

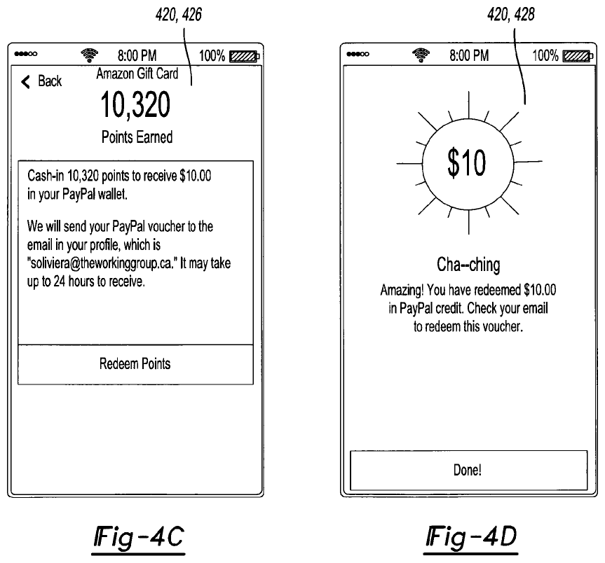

The consumer can be enabled to select one or more payout options and the user's app can use an API for the payment to pass the fiat. Payout options can for example include PayPal, Amazon Pay, and/or other payment mechanisms. For example, as shown in FIGS. 4A-4D, a user 190 can be presented with a series of UIs 420, 422-428 adapted to enable the user to select a command item 440, 442 to access data representing virtual giftcards or at 444 cash equivalents, and to make desired selections; and/or 446 to redeem loyalty points for cash equivalent, for storage on the user's device 100 or for initiating one or more electronic purchase transactions.

As previously noted, in various aspects and embodiments the invention makes use of secure, third-party and/or otherwise distributed data storage, including, for example, systems making use of blockchain and other forms of secure public ledger technologies.

In such embodiments, any trusted network component, including any or all of components 100, 200, 300, etc., can serve as a node for storage of data relevant to the component. For example, a user 190's device 100 can serve as a secure node for storage of all information relating to the consumer 190 associated with the user's device's data sharing control app, such as demographic and behavioral (including all PII), locally on the device. Similarly, brand or other data miner systems 300 can serve as nodes or wallets, to enable use of virtual wallet-to-wallet transactions on blockchain system(s), with handshake functionalities being facilitated by responsible data sharing controller(s) 200.

In such embodiments it can be advantageous for data sharing controllers 200 and applications to be blockchain or ledger indifferent, meaning for example that systems 1000 can be implemented on the Ethereum, with the option to add or switch to any other blockchain(s).

In many such embodiments of the invention, a single PII agreement data set can be routed to both sharers 190 and miners 300 of PII, with data representing the various parameters of the agreement being updated in blockchain fashion, so that new blocks are generated and stored in response to each transaction.

As noted above, systems 1000 in accordance with the invention may be implemented in a wide variety of variations. While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above.

Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A data sharing management system configured for controlling secure, verified access to data records representing personally-identifiable data over an electronic communications network, the data sharing management system configured to:
receive, from a plurality of user devices by means of an electronic communications network, signals representing a plurality of transaction consent data sets, each transaction consent data set comprising a plurality of encrypted data records;
at least one of said encrypted data records representing at least one identifier associated with an authorized data custodian, the same or at least one other of said encrypted data records further representing at least one request transaction identifier associated with a request for personally-identifiable information received by the data sharing management system from at least one data mining system;
the same or at least one other of said encrypted data records representing personally-identifiable data authorized by the custodian to be communicated to the at least one data mining system in response to the request for personally-identifiable information;
using the at least one identifier associated with the authorized data custodian and the data representing the at least one transaction identifier, determine whether the transaction consent data set represents a valid consent for release of personally-identifiable information;
conditioned upon verification that the transaction consent data set represents a valid consent for release of personally-identifiable information, generate a transaction response data set, the transaction response data set comprising at least one or more data records representing the personally-identifiable data authorized by the custodian for communication to the at least one data mining system; and
route the transaction response data set to the at least one data mining system over the same or another electronic communications network.

2. The data sharing management system of claim 1, wherein the transaction consent data set received from the user device comprises data representing:
a date and time at which the transaction consent data set was generated by the user device from which it was received, and
a cryptographic signature associated with the authorized data custodian; and the data management sharing system is configured to:
store in a secure memory architecture individual hashes of at least two of:
the data representing the cryptographic signature of the authorized data custodian;
the data representing the date and time at which the transaction consent data set was generated by the user device;
a date and time at which the transaction consent data set was received by the data sharing management system; and
the request transaction identifier.

3. The data sharing management system of claim 2, wherein the individual hashes are stored in the secure memory architecture in accordance with a time dimension.

4. The data sharing management system of claim 2, wherein the individual hashes are stored in a permanent public data ledger prior to the routing of the transaction response data set to the at least one data mining system.

5. A data sharing management system configured for controlling secure, verified access to data records representing personally-identifiable data over an electronic communications network, the data sharing management system configured to:
receive, by means of an electronic communications network, from at least one network communication device, signals representing plurality of transaction consent data sets, each of the transaction consent data set comprising a plurality of data records, the plurality of data records representing:
at least one identifier associated with an authorized data custodian,
at least one request transaction identifier associated with a request for personally-identifiable information received by the data sharing management system from at least one data mining system;
personally-identifiable data authorized by the custodian to be communicated to the at least one data mining system in response to the request for personally-identifiable information;
a date and time at which the transaction consent data set was generated by the user device from which it was received, and
a cryptographic signature associated with the authorized data custodian;
verify that each of the received transaction consent data sets represents a valid consent for release of personally-identifiable information to the corresponding at least one data mining system;
with respect to each verified consent data set, generate individual hashes of at least two of:
the data representing the cryptographic signature of the authorized data custodian;
the data representing the date and time at which the verified transaction consent data set was generated by the corresponding network communication device;
a date and time at which the verified transaction consent data set was received by the data sharing management system; and
the request transaction identifier;
using at least the corresponding individual hashes, generate a plurality of encrypted verified data-sharing consent records; and
store the plurality of encrypted verified data-sharing records in a secure memory architecture.

6. The data sharing management system of claim 5, wherein each of the plurality of verified encrypted data-sharing consent records is stored in the secure memory architecture in accordance with a time dimension, based on at least one of:
the date and time at which the corresponding transaction consent data set was generated by the user device from which it was received, and
the date and time at which the corresponding verified transaction consent data set was received by the data sharing management system.

7. The data sharing management system of claim 5, configured to:
access, in the secure memory architecture, a plurality of verified encrypted data-sharing consent records stored in the secure memory architecture within a specified time range;
generate, using a plurality of the individual hashes of each of the encrypted verified data-sharing consent records, a combined encrypted verified data-sharing consent record; and
store the combined encrypted verified data-sharing consent records in the same or another secure memory architecture in accordance with a time dimension.

8. The data sharing management system of claim 5, configured, conditioned upon the verification that each of the plurality of received transaction consent data sets represents a valid consent for release of personally-identifiable information to a corresponding at least one data mining system; route to the corresponding at least one data mining system a transaction response data set, the transaction response data set comprising at least one or more data records representing personally-identifiable data authorized for sharing by the corresponding data custodian.

9. The data sharing management system of claim 8, configured to store the verified encrypted data-sharing consent record in the secure memory architecture prior to routing the transaction response data set to the corresponding at least one data mining system.

10. The data sharing management system of claim 9, wherein the verified encrypted data-sharing consent record is stored in a permanent public data ledger.

11. A data sharing management system configured for controlling secure, verified access to data records representing personally-identifiable data over an electronic communications network, the data sharing management system configured to:
generate, using information received from one or more data mining systems over an electronic communications network, a specific transaction consent request data set, the specific transaction request data set comprising data records representing at least:
a specific consent request identifier uniquely associated with a specific data transaction request;
a date and time at which the specific transaction request data set is generated;
an identifier associated with at least one data mining system;
an identifier associated with a purpose of the specific data transaction request;
a length of time for which a consent responsive to the specific data transaction request is requested to be valid;
one or more identifiers associated with one or more types of requested data associated with the specific data transaction request;
one or more encryption identifiers associated with encryption algorithms to be used in encrypting the requested data;
using at least one algorithm associated with the one or more encryption identifiers, encrypt the specific transaction consent request data set;
store the specific transaction consent request data set and the encrypted specific transaction consent request data set in secure memory controlled by the data sharing management system;
store the encrypted specific transaction consent request data set in a secure public data ledger;
using the same or another electronic communication system, route to at one least data custodian communication device signals representing the specific transaction consent request data set;
receive from the at least one data custodian communication device signals representing at least one specific transaction consent data set, the specific transaction consent data set comprising encrypted data representing at least:
the specific consent request identifier;
a signature representing authorization to generate the specific transaction consent data set;
a date and time at which the specific transaction consent data set was generated; and
at least one encryption identifier associated with an encryption algorithm used to encrypt at least a part of the specific transaction consent data set;
store the specific transaction consent data set in secure memory controlled by the data sharing management system; and
store the specific transaction consent data set in a secure public data ledger.

12. The data sharing management system of claim 12, configured to:
conditioned upon verification that the specific transaction consent data set represents a valid consent for release of personally-identifiable information,
generate an encrypted specific consent recordation set, the encrypted specific consent recordation set comprising at least at least the specific transaction consent data set, and store the encrypted specific consent recordation set in a permanent public ledger; and
subsequent to storing the encrypted specific transaction consent data set in the permanent public ledger, generate a specific transaction response data set, the specific transaction response data set comprising at least one or more data records representing the personally-identifiable data authorized by the specific transaction consent data set for communication to the at least one data mining system; and
route the specific transaction response data set to the at least one data mining system over the same or another electronic communications network.

13. Machine-readable programming products stored in persistent memory and adapted for configuring data sharing management systems in accordance with any of claims 1-12.

14. Methods, performed by data sharing management systems or programming products in accordance with any of claims 1-13.

15. Custodian network communication devices configured to generate communications used by data sharing management systems in implementing processes in accordance with any of claims 1-14.

16. Machine-readable programming products stored in persistent memory and adapted for configuring custodian network communication devices in accordance with claim 15.

17. Methods, performed by custodian network communication devices or programming products in accordance with claim 15.
